(19) United States
(12) Patent Application Publication
(10) Pub. No.: US 2017/0212074 A1
(43) Pub. Date: Jul. 27, 2017

(54) GAS SENSOR

(71) Applicant: NGK SPARK PLUG CO., LTD., Nagoya-shi (JP)

(72) Inventors: Takehiro OBA, Kounan-shi (JP); Shogo NAGATA, Komaki-shi (JP); Shunya MIHARA, Komaki-shi (JP)

(73) Assignee: NGK SPARK PLUG CO., LTD., Nagoya-shi (JP)

(21) Appl. No.: 15/414,713

(22) Filed: Jan. 25, 2017

(30) Foreign Application Priority Data
Jan. 27, 2016 (JP) 2016-013590

(51) Int. Cl. G01N 27/407

(52) U.S. Cl. CPC G01N 27/4077

(57) ABSTRACT

A gas sensor (1) including a detection element (3) extending in an axial direction indicated by the axial line (O); a tubular metal shell (29) holding the detection element, and surrounding a periphery of the detecting element in a radial direction; a tubular outer casing (33) attached to the metal shell, extending rearward from the metal shell, and having first vent holes (33h) for introducing external air into the outer casing; an air permeable filter (37) provided radially outside the outer casing, covering the first vent holes; and a tubular protective outer casing (39) provided radially outside and around the filter, and having second vent holes (39h) which are in communication with the filter. The diameter of each second vent hole is smaller than the diameter of each first vent hole, and the number of the second vent holes is larger than the number of the first vent holes.

### BACKGROUND OF THE INVENTION

1. Field of the Invention

The present invention relates to a gas sensor equipped with a detection element for detecting the concentration of a gas to be detected.

2. Description of the Related Art

Among gas sensors for detecting the concentration of a specific gas (e.g., oxygen or NOₓ) in the exhaust gas of automobiles, etc., one that has a detection element which employs a solid electrolyte is known.

A known gas sensor of this kind, for example, is configured to have a detection element extending along the axial direction that is held so as to be radially surrounded by a metal shell, and an outer casing that is attached to the rear side of a metal shell (Patent Document 1). In this gas sensor, a first vent hole is formed in the lateral surface of the outer casing so that external air having a reference oxygen concentration is introduced to the detection element in the outer casing. The first vent hole is covered by an air-permeable filter, which is then covered by a protective outer casing from the outside of the filter, and the protective outer casing and the outer casing are crimped so that the filter is fixed. The protective outer casing also has a second vent hole which is in communication with the filter so that external air is introduced into the outer casing through the filter.

[Patent Document 1] Japanese Patent Application Laid-Open (kokai) No. H08-145939 (FIG. 3)

### PROBLEMS TO BE SOLVED BY THE INVENTION

In the above gas sensor, the filter is exposed to the outside from the second vent hole of the protective outer casing. Therefore, external foreign matter, such as water droplets during washing of a vehicle or snow during traveling, is likely to come into direct contact with the filter. Therefore, in order to inhibit external foreign matter from directly contacting the filter, the gas sensor disclosed in Patent Document 1 is configured so that the diameter of the second vent hole is smaller than the diameter of the first vent hole.

However, when the diameter of the second vent hole is smaller than that of the first vent hole, the second vent hole imparts ventilation resistance, likely leading to a decrease in air permeability of the filter.

### SUMMARY OF THE INVENTION

Thus, an object of the present invention is to provide a gas sensor which is capable of maintaining the air permeability of the filter and which is able to inhibit direct contact of external foreign matter with the filter.

The above object has been achieved by providing (1) a gas sensor comprising a detection element extending in an axial direction; a tubular metal shell holding the detection element, and surrounding a periphery of the detection element in a radial direction; a tubular outer casing attached to the metal shell, extending rearward from the metal shell, and having first vent holes for introducing external air into the outer casing; an air permeable filter provided radially outside the outer casing, covering the first vent holes; and a tubular protective outer casing provided radially outside and around the filter, and having second vent holes which are in communication with the filter. A diameter of each second vent hole is smaller than a diameter of each first vent hole, and the number of the second vent holes is larger than the number of the first vent holes.

According to the gas sensor (1), the diameter of each second vent hole is smaller than the diameter of each first vent hole. Therefore, even when the filter is exposed to the outside from the second vent holes, direct contact of external foreign matter with the filter can be inhibited. The number of the second vent holes is larger than the number of the first vent holes. Therefore, a decrease in the air permeability of the filter due to the ventilation resistance of the second vent holes, each of which has a diameter smaller than that of the first vent holes, can be inhibited.

In a preferred embodiment (2) of the gas sensor (1) above, a total area of the second vent holes is 70% to 130% of a total area of the first vent holes.

According to the gas sensor (2), the ventilation resistance of the second vent holes is close to that of the first vent holes. Therefore, a decrease in air permeability of the filter due to the ventilation resistance of the second vent holes can be inhibited.

In another preferred embodiment (3) of the gas sensor (1) or (2) above, the second vent holes each has a diameter of 2.0 mm or less.

According to the gas sensor (3), direct contact of external foreign matter with the filter can be further inhibited.

In yet another preferred embodiment (4) of the gas sensor of any of (1) to (3) above, a region, in the axial direction, where any of the second vent holes is present may overlap a region, in the direction of the axial line, where any of the first vent holes is present, and the second vent holes and the first vent holes do not overlap each other in a circumferential direction.

According to the gas sensor (4), the second vent holes at least partially coincide with the first vent holes in the axial direction. Therefore, the height of the gas sensor in the axial direction indicated by the line O can be reduced, resulting in a reduction in the size of the gas sensor. When the filter is fixed between the protective outer casing and the outer casing by crimping, it is necessary to provide a space for accommodating the crimped section in the axial direction. The arrangement of the second vent holes and the first vent holes so that they coincide with each other in the axial direction, ensures that the above space is provided, and that the filter is fixed by crimping.

The arrangement of the second vent holes and the first vent holes so that they do not overlap each other in the circumferential direction, can effectively inhibit damage to the filter which could otherwise be caused by contact of external foreign matter with the filter.

Referring to FIG. 2, the term “region, in the axial direction, where the second vent hole is present” means an axial (band-shaped) region 39R, which is covered by the second vent hole 39h, of the outer peripheral surface of the protective outer casing 39. The term “region, in the axial direction, where the first vent hole is present” means an axial (band-shaped) region 33R, which is covered by the first vent hole 33h, of the outer peripheral surface of the outer casing 33. The term “the region, in the axial direction, where the second vent hole is present overlaps the region, in the axial direction, where the first vent hole is present” means that the axial region 39R which is covered by the second vent hole 39h overlaps the axial region 33R, in the axial direction, which is covered by the first vent hole 33h.

In other words, the second vent holes and the first vent holes are arranged so that while the second vent holes and the first vent holes do not overlap in a circumferential direction, a region (band), in the axial direction, obtained by projecting the second vent holes thereonto overlaps a region (band), in the axial direction, obtained by projecting the first vent holes thereonto.

In yet another preferred embodiment (5) of the gas sensor of any of (1) to (4) above, the protective outer casing has a front end edge separated from an outer surface of the outer casing.

According to the gas sensor (5), even when the front side of the gas sensor is exposed to and heated by a gas to be detected, and heat is transferred to the rear side of the gas sensor through the outer casing, the front end edge of the protective outer casing separated from the outer surface of the outer casing functions as a heat dissipation section for dissipating the heat. As a result, the creepage (shrinkage), due to heat, of the filter provided between the outer casing and the protective outer casing and a resultant decrease in air permeability or sealing performance, can be inhibited.

### EFFECTS OF THE INVENTION

According to the present invention, a gas sensor is obtained which is capable of maintaining the air permeability of the filter and which is able to inhibit direct contact of external foreign matter with the filter.

### BRIEF DESCRIPTION OF THE DRAWINGS

FIG. 1 is a cross-sectional view showing a gas sensor according to an embodiment of the invention, taken along a plane in the axial direction.

FIG. 2 is a partial cross-sectional view showing a portion in the vicinity of a filter in FIG. 1.

FIG. 3 is a perspective view showing an outer casing before crimping.

FIG. 4 is a perspective view showing a protective outer casing before crimping.

FIG. 5 is a perspective view showing the outer casing and the protective outer casing after crimping.

### DESCRIPTION OF REFERENCE NUMERALS

Reference numerals used to identify various features in the drawings are described below. However, the present invention should not be construed as being limited thereto.

1: gas sensor; 3: detection element; 29: metal shell; 33: outer casing; 33h: first vent hole; 33R: region where first vent hole is present; 37: filter; 39: protective outer casing; 39f: front end edge of protective outer casing; 39h: second vent hole; 39R: region where second vent hole is present; and O: axial line

### DETAILED DESCRIPTION OF THE PREFERRED EMBODIMENTS

The present invention will next be described with reference to the drawings. However, the present invention should not be construed as being limited thereto.

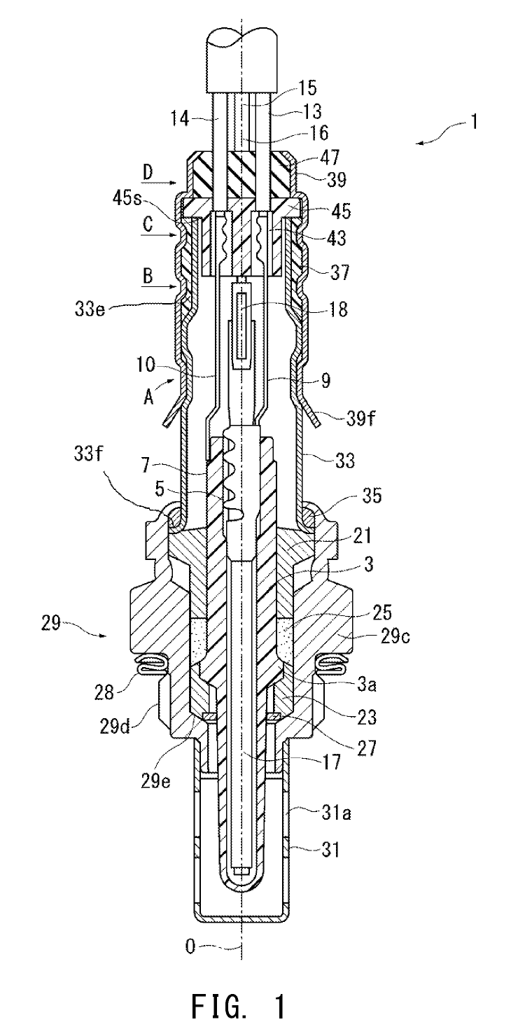

FIG. 1 shows a cross-sectional structure of an oxygen sensor (gas sensor) 1 according to an embodiment of the invention, taken along a plane extending in the axial direction indicated by the axial line O (in a direction from the front end to the rear end). In this embodiment, the oxygen sensor 1 is inserted into an exhaust pipe of an automobile so that the front end (a protective cap 31 shown in FIG. 1) thereof is exposed to exhaust gas, and detects the concentration of oxygen in the exhaust gas.

In FIG. 1, the lower side (the side of the protective cap 31) of the oxygen sensor 1 is referred to as a front side of the oxygen sensor 1, and the upper side of FIG. 1 is referred to as a rear side of the oxygen sensor 1.

In the oxygen sensor 1, a detection element 3 is fixed in a housing (metal shell) 29. The detection element 3 is a known oxygen detection element which is configured as an oxygen concentration cell in which a pair of electrodes 5 and 7 are laminated on an oxygen ion-conductive solid electrolyte body extending in the axial direction. The detection element 3 outputs a detected value depending on the concentration of oxygen. Specifically, the detection element 3 includes a solid electrolyte body which is in the shape of a tapered tube with a closed bottom, the diameter of which gradually becomes narrower toward the front end, and an inner electrode 5 and an outer electrode 7 which are formed on the inner peripheral surface and the outer peripheral surface, respectively, of the solid electrolyte body. The inner space of the detection element 3 is set to be in a reference gas atmosphere, and the outer surface of the detection element 3 is brought into contact with a gas to be detected, for detection of the gas.

A flange section 3a protruding radially outward is provided around the center of the detection element 3. Meanwhile, a step section 29e, the diameter of which gradually becomes narrower inward, is provided on the inner peripheral surface of the metal shell 29 close to the front end. A packing 27 and a tubular ceramic member 23 are provided in that order on the step section 29e. The detection element 3 is inserted into the metal shell 29 so that the flange section 3a is brought into contact with the ceramic member 23, and therefore, the flange section 3a of the detection element 3 indirectly butts the step section 29e from the rear side. Thus, the detection element 3 is fixed in the metal shell 29.

A rod heater 17 for heating the detection element 3 is inserted in a U-shaped inner space of the detection element 3.

A gap in the radial direction between the detection element 3 and the metal shell 29, at the rear side of the flange section 3a, is filled with a tubular sealing member (talc powder) 25. A tubular insulating member (ceramic sleeve) 21 is provided to the rear side of the sealing member 25.

An outer casing 33 made of a heat-resistant metal, such as stainless steel, is attached to the rear side of the metal shell 29, by crimping, with an O-ring 35 being interposed therebetween, such that the outer casing 33 surrounds and covers the rear side of the detection element 3 and the heater 17.

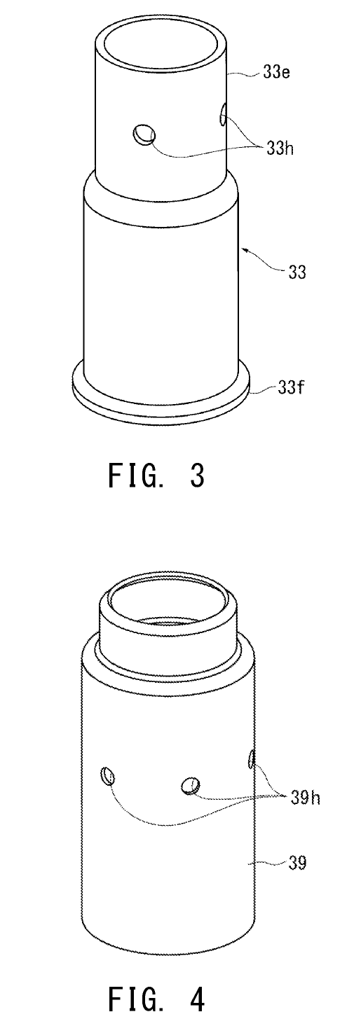

The O-ring 35, and a flange section 33f (see FIG. 3) at the front end of the outer casing 33, are positioned at the rear side of the metal shell 29. A rear end section of the metal shell 29 is bent inward and crimped. As a result, the insulating member 21 is pushed forward, so that the sealing member 25 is crushed. As a result, the insulating member 21 and the sealing member 25 are crimped and fixed, thereby sealing the gap between the detection element 3 and the metal shell 29.

A protective outer casing 39 made of a heat-resistant metal, such as stainless steel, is fitted onto the outer surface of the rear side of the outer casing 33 with a filter 37 described below being interposed therebetween.

The outer casing 33 and the protective outer casing 39 are fixed to each other by crimping at around the center of the outer casing 33 in the axial direction, to provide a crimped section A. At the crimped section A, not only the protective outer casing 39 but also the outer casing 33 are strongly pressed so as to be recessed and deformed radially inward.

A rear end section 33e (see FIG. 3) having a smaller diameter is formed to the rear side of the crimped section A of the outer casing 33. The filter 37 is interposed in an inner space between the rear end section 33e having a smaller diameter and the protective outer casing 39.

The protective outer casing 39 protrudes rearward from the outer casing 33, and has an open end.

An insulating tubular separator 45 is provided, covering the opening at the rear end of the outer casing 33. The separator 45 has two insertion holes 43, into which base sections of metal terminals 9 and 10 are respectively inserted. Lead wires 13 and 14 are respectively connected to the base sections by crimping.

The separator 45 has a front end section having a diameter smaller than that of the outer casing 33, and a rear end section having a diameter larger than that of the outer casing 33, which are connected together by a step section 45s. The front end section of the separator 45 is inserted into a rear end section of the outer casing 33 so that the step section 45s butts the rear end edge of the outer casing 33, and therefore, the separator 45 is positioned in the outer casing 33.

A tubular grommet (elastic member) 47 is provided inside the protective outer casing 39 at a rear end section thereof so that the grommet 47 is in contact with the rear end section of the separator 45. The grommet 47 is fixed by crimping the protective outer casing 39, to form a crimped section D. The grommet 47 may be an elastic member made of, for example, silicone rubber, fluorine rubber, etc.

The grommet 47 has four insertion holes penetrating therethrough. The lead wires 13 and 14 extend outside through the insertion holes 43 of the separator 45 and the insertion holes of the grommet 47. The separator 45 has two more insertion holes penetrating therethrough (not shown). Two lead wires 15 and 16 connected to an electrode 18 of the heater 17, extend outside through the insertion holes of the separator 45 and the grommet 47.

The metal terminal 9, which has a tube shape, is fitted into the detection element 3 to be electrically connected to the inner electrode 5 provided in the detection element 3. The metal terminal 10, which has a tube shape, is fitted onto the outer surface of the detection element 3 so as to be electrically connected to the outer electrode 7 provided outside the detection element 3.

Meanwhile, the tubular protective cap 31, which is made of a metal (stainless steel, etc.) and has an opening 31a, is fixed to the front end of the metal shell 29. The front end of the detection element 3, protruding from the metal shell 29, is covered by the protective cap 31. The protective cap 31 has a plurality of holes for receiving exhaust gas into the protective cap 31.

A polygonal flange section 29c which protrudes radially outward and is used for engaging a hexagonal wrench, etc., is provided at around the center of the metal shell 29. A male threaded section 29d is formed on the outer lateral surface of the metal shell 29 at the front side of the flange section 29c. A gasket 28 for preventing gas leakage when attached to an exhaust pipe, is fitted into a step section between the front end surface of the flange section 29c and the rear end of the male threaded section 29d.

The male threaded section 29d of the metal shell 29 is attached to a threaded hole of an exhaust pipe, etc., so that the front end of the detection element 3 is exposed inside the exhaust pipe in order to detect a gas to be detected (exhaust gas).

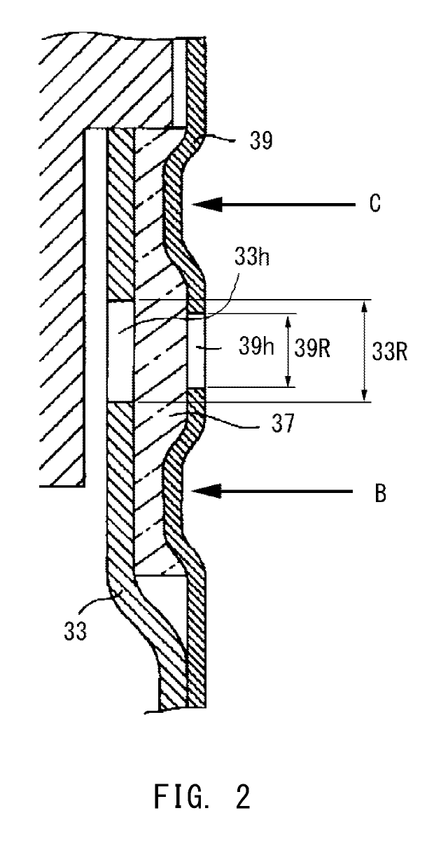

Next, referring to FIG. 2, the arrangement in which the filter 37 is provided between the outer casing 33 and the protective outer casing 39 will be described.

Four (only one is shown in FIG. 2) openings referred to as first vent holes 33h are provided in the lateral surface of the outer casing 33 at the rear end, so as to be equally spaced in the circumferential direction. External air can be introduced into the outer casing 33 through the first vent holes 33h. The annular air-permeable filter 37 is provided radially outside the outer casing 33, covering the first vent holes 33h. The protective outer casing 39 is provided radially outside and around the filter 37. Six (only one is shown in FIG. 2) openings referred to as second vent holes 39h are provided in the lateral surface of the protective outer casing 39 so as to be equally spaced in the circumferential direction. A portion of the outer surface of the filter 37 is exposed through the second vent holes 39h so that the second vent holes 39h are in communication with the filter 37, and therefore, external air is introduced into the outer casing 33 through the filter 37.

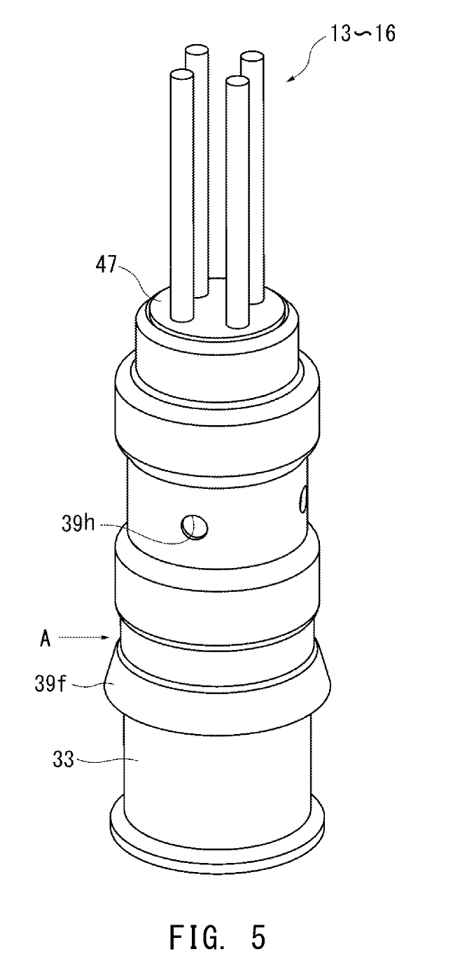

A rear end section of the protective outer casing 39 is bent radially inward so as to be disposed on the rear end surface of the grommet 47 (see FIG. 5). The insertion holes of the grommet 47 face the opening formed at the center of the rear end section. The lead wires 13-16 extend outside the gas sensor.

The filter 37 has a porous structure made of a resin such as a fluorine-based resin (e.g., TEFLON® (registered trademark), etc.). The filter 37 therefore has water repellency and thereby allows introduction of a reference gas (atmospheric air) into the internal space of the detection element 3 while preventing the passage of external water. A filter 37 having a thickness range of 0.5 mm to 2.0 mm before crimping and 0.2 mm to 1.0 mm after crimping is preferable since it exhibits sufficient water resistance and shock resistance. A filter 37 having a length range of 8 mm to 20 mm in the axial direction is preferable since it exhibits sufficient water resistance and shock resistance.

The outer casing 33 and the protective outer casing 39 are crimped at two portions, i.e., at the front and rear sides of the first vent hole 33h and the second vent hole 39h with the filter 37 being interposed therebetween. As a result, a front crimped section B and a rear crimped section C are provided.

The protective outer casing 39 is deformed and recessed radially inward at the front crimped section B and the rear crimped section C. The outer casing 33 is crimped without being radially deformed. In addition to the protective outer casing 39, the outer casing 33 may be strongly crimped to the extent that outer casing 33 is deformed and recessed radially inward.

The front crimped section B and the rear crimped section C are preferably formed by crimping without deforming the hole shapes of the first vent holes 33h and the second vent holes 39h. As a result, an accurate amount of gas passing through the first vent holes 33h and the second vent holes 39h can be ensured.

Examples of crimping which can be employed include hexagonal crimping, octagonal crimping, and round crimping.

The outer casing 33 and the protective outer casing 39 may have a thickness of 0.2 mm to 0.8 mm.

Next, referring to FIGS. 3 and 4, the outer casing 33 and the protective outer casing 39, which are a characteristic feature of the present invention, will be described.

The outer casing 33 shown in FIG. 3 has four first vent holes 33h each having a diameter of 2.2 mm in the rear end section 33e. The protective outer casing 39 shown in FIG. 4 has six second vent holes 39h each having a diameter of 1.8 mm.

Thus, the diameter of each second vent hole 39h is smaller than the diameter of each first vent hole 33h. As a result, even when the filter is exposed to the outside from the second vent holes 39h, direct contact of external foreign matter with the filter 37 can be inhibited. The number of the second vent holes 39h is greater than the number of the first vent holes 33h. Therefore, a decrease in air permeability of the filter 37 due to the ventilation resistance of the second vent holes 39h, each of which has a diameter smaller than that of the first vent holes 33h, can be inhibited.

The diameters of the second vent holes 39h and the first vent holes 33h are based on the respective circle conversion diameters. When the diameters of the second vent holes 39h vary, the average value of the diameters of the holes is defined as the diameter of the second vent holes 39h. When the diameters of the first vent holes 33h vary, the average value of the diameters of the holes is defined as the diameter of the first vent holes 33h.

When the total area of the second vent holes 39h is 70% to 130% of the total area of the first vent holes 33h, the ventilation resistance of the second vent holes 39h is close to that of the first vent holes 33h, and therefore, the decrease in the air permeability of the filter 37 due to the ventilation resistance of the second vent holes can be further inhibited. The total area of the second vent holes 39h is represented by multiplying the diameter of the second vent holes 39h by the number of the second vent holes 39h. The same is true of the total area of the first vent holes 33h.

When the diameter of each second vent hole 39h is 2.0 mm or less, direct contact of external foreign matter with the filter 37 can be further inhibited. In terms of inhibition of damage to the filter 37, each second vent hole 39h preferably has a smaller diameter.

As shown in FIG. 2, preferably, in the axial direction, the region where the second vent hole 39h is present should coincide with the region where the first vent hole 33h is present, and, in the circumferential direction, the second vent hole 39h should not coincide with the first vent hole 33h.

When the second vent holes 39h partially coincide with the first vent holes 33h in the axial direction, the height of the gas sensor 1 in the direction of the axial line O can be reduced, resulting in a reduction in size of the gas sensor 1. When the filter 37 is fixed between the protective outer casing 39 and the outer casing 33 by crimping, it is necessary to provide a space for accommodating the crimped section in the axial direction. The arrangement of the second vent holes 39h and the first vent holes 33h so that they coincide with each other in the axial direction, ensures that the above space is provided, and the filter is fixed by crimping.

Meanwhile, if the second vent holes 39h even partially coincide with the first vent holes 33h in the circumferential direction, the filter 37 is not held by the protective outer casing 39 or the outer casing 33, in the overlapping portion. In this case, if external foreign matter comes into contact with the filter 37, the matter is likely to penetrate through and damage the filter 37. Therefore, the arrangement of the second vent holes 39h and the first vent holes 33h so that they do not overlap each other in the circumferential direction, can effectively inhibit damage to the filter 37.

As shown in FIGS. 1 and 5, in this embodiment, the protective outer casing 39 has a front end edge 39f gradually extending radially outward so as to be separated from the outer surface of the outer casing 33.

Therefore, even when the front side of the gas sensor 1 is exposed to and heated by a gas to be detected, and heat is transferred to the rear side of the outer casing 33, the front end edge 39f of the protective outer casing 39 separated from the outer surface of the outer casing 33 functions as a heat dissipation section for dissipating the heat. As a result, the creepage (shrinkage), due to heat, of the filter 37 provided between the outer casing 33 and the protective outer casing 39 and a resultant decrease in air permeability or sealing performance can be inhibited.

A working process of expanding the front end edge 39f is performed after the protective outer casing 39 is placed over the outer casing 33 and the crimped section A is formed.

Next, an example method for fabricating the oxygen sensor 1 of this embodiment will be described. Initially, the tubular filter 37 is fitted onto the outer surface at the rear side of the outer casing 33, and the separator 45 to which the metal terminals 9 and 10 are attached is placed at the rear side of the outer casing 33. At this time, the step section 45s of the separator 45 is brought into contact with the rear end of the outer casing 33. Next, the protective outer casing 39 is placed over the outer surface of the outer casing 33, and both are crimped to form the crimped section A so that the outer casing 33 and the protective outer casing 39 are fixed together. Furthermore, the grommet 47 is placed in the protective outer casing 39 and is brought into contact with the rear end of the separator 45, followed by crimping thereof, to form the crimped section D. Next, the outer casing 33 and the protective outer casing 39 are crimped with the filter 37 being interposed therebetween so that the front crimped section B and the rear crimped section C are formed.

Thereafter, the oxygen sensor 1 is fabricated using a known method. Specifically, the outer casing 33, to which the protective outer casing 39 is fixed, is joined to a lower assembly including the detection element 3, the metal shell 29, the protective cap 31, etc. The O-ring 35 and the outer casing 33 are placed at the rear side of the metal shell 29, and are fixed by bending inward and crimping the rear end section of the metal shell 29.

The present invention is not limited to the above embodiments, and covers various modifications, equivalents, etc., falling within the spirit and scope of the present invention.

For example, as the detection element, an element having electromotive force which varies depending on the oxygen concentration or an element having a resistance value which varies depending on the oxygen concentration can be employed. As the solid electrolyte body of the detection element, an oxygen ion conductive solid electrolyte, such as zirconia or yttria, can be employed. As the detection element, in addition to the above oxygen sensor element (a λ sensor element), a wide-range air-fuel ratio sensor element, a NOx sensor element, and an ammonia sensor element can be used. The detection element may be in the shape of a plate, instead of a tube.

The positions where the first vent holes 33h and the second vent holes 39h are formed, and the numbers of the first vent holes 33h and the second vent holes 39h, are not limited to those described above. Furthermore, in this embodiment, the filter 37 has an annular shape. The present invention is not limited thereto. For example, the filter may only partially cover the surface in the circumferential direction, provided that the filter allows communication between the first vent holes 33h and the second vent holes 39h.

In the above embodiments, the grommet (elastic member) is fitted into the rear side of the protective outer casing to seal the opening at the rear side of the protective outer casing. Alternatively, when the outer casing is extended rearward from the protective outer casing, the grommet may be fitted into the rear side of the outer casing to seal the outer casing (and the protective outer casing).

In the above embodiments, the present invention is applied to a gas sensor of a type in which external air having a reference oxygen concentration is introduced to the detection element. However, the present invention is not limited thereto. For example, the present invention is applicable to a gas sensor of a type in which external air is introduced through a filter in order to prevent dew condensation in the gas sensor. If dew condensation occurs in the gas sensor, water adheres to a space between the base portions of adjacent metal terminals attached to insertion holes of the separator. This can result in a short circuit malfunction occurring between the terminals.

The invention has been described in detail with reference to the above embodiments. However, the invention should not be construed as being limited thereto. It should further be apparent to those skilled in the art that various changes in form and detail of the invention as shown and described above may be made. It is intended that such changes be included within the spirit and scope of the claims appended hereto.

This application is based on Japanese Patent Application No. 2016-013590 filed Jan. 27, 2016, the above-noted application incorporated herein by reference in its entirety.

What is claimed is:

1. A gas sensor comprising:
a detection element extending in an axial direction;
a tubular metal shell holding the detection element, and surrounding a periphery of the detection element in a radial direction;
a tubular outer casing attached to the metal shell, extending rearward from the metal shell, and having first vent holes for introducing external air into the outer casing;
an air permeable filter provided radially outside the outer casing, covering the first vent holes; and
a tubular protective outer casing provided radially outside and around the filter, and having second vent holes which are in communication with the filter, wherein
a diameter of each second vent hole is smaller than a diameter of each first vent hole, and a number of the second vent holes is larger than a number of the first vent holes.

2. The gas sensor as claimed in claim 1, wherein a total area of the second vent holes is 70% to 130% of a total area of the first vent holes.

3. The gas sensor as claimed in claim 1, wherein the second vent holes each has a diameter of 2.0 mm or less.

4. The gas sensor as claimed in claim 1, wherein a region, in the axial direction, where any of the second vent holes is present overlaps a region, in the axial direction, where any of the first vent holes is present, and the second vent holes and the first vent holes do not overlap each other in a circumferential direction.

5. The gas sensor as claimed in claim 1, wherein the protective outer casing has a front end edge separated from an outer surface of the outer casing.
